(19) United States
(12) Patent Application Publication
(10) Pub. No.: US 2005/0036883 A1
(43) Pub. Date: Feb. 17, 2005

(54) Game loader and method

(76) Inventor: Donald Edleston, Walker, LA (US)

Correspondence Address: Roy, Kiesel, Keegan and DeNicola;2355 Drusilla Lane (70809), P.O. Box 15928, Baton Rouge, LA, 70895-5928, US

(21) Appl. No.: 10/638,847

(22) Filed: Aug. 11, 2003

(51) Int. Cl. B66F 7/02

(52) U.S. Cl. 414/800

(57) ABSTRACT

The invention is drawn to a game loader having a flat surface area, reinforced to enable use with heavy objects that is connected on one end to a stationary object, such as a tree or pole, and is connected on the other end to a vehicle or movable object, such that increased tension between these two points hoists the object loaded onto the game loader to a higher position, enabling the load to be rolled with little effort to the vehicles' loading platform. When not being used for this loading technique, the game loader can be extended over the vehicle to provide shelter and protection to the vehicle below.

### BACKGROUND OF THE INVENTION

This invention relates to a device used for loading game onto a vehicle, permitting a single person to load a large, heavy object alone, as well as performing other functions related to game hunting.

The desirability of providing a lightweight and portable game loader is a field in which there has been a long-felt need in the industry. Still hunting is often an activity that is done alone, therefore when an animal is taken (or killed), often it must be brought back to camp by a single person. Even though the animal can be field dressed, whereby most of the innards are removed, many large game can still weigh hundreds of pounds. This weight would be difficult for two people to lift, but is largely impossible for a single person to hoist onto his vehicle or otherwise transport. Dragging the animal is an alternate option, but is still extremely strenuous and sometimes impossible for smaller persons, the elderly or infirm, children and women. Solutions for this problem have been known in the art, but are generally ineffectual and/or involve heavy or cumbersome equipment.

An additional concern of many hunters is that proper care cannot be afforded to their all-terrain vehicles (ATVs) during the hunting season. As a result, ATVs can become dirty and/or damaged because of a lack of protection. Heavy rains and dirt can also make operation of the vehicle inconvenient since the seating area of the vehicle is exposed to the elements. Thus, a portable cover for the ATVs is a desirable item for the hunter as well.

Many hunters choose to take a break between the morning and afternoon hunts when the animals are least active. Thus, another need while hunting is to have a place to rest or relax between these hunts. A portable lounger or hammock would thus be ideal to have while hunting.

Unfortunately, toting all of these items into the woods is not only an arduous task, but also physically impossible for most hunters. Thus, it would be desirable to have a lightweight and simple variant of any or all of these items for still hunting.

### OBJECTS OF THE INVENTION

One object of this invention is to provide a game loader that permits a single operator to load game or other heavy objects, such as game onto a vehicle alone.

Another object of this invention is to provide a game loader that is able to be used as a protective shelter for a vehicle.

Still another object of this invention is to provide a game loader that is capable of serving as a seat and/or lounge for the operator to use.

Yet another object of this invention is to provide a game loader that is portable, lightweight and small to permit ease of use, storage and transport.

Other objects and advantages of this invention will be apparent from the ensuing descriptions of this invention.

### SUMMARY OF THE INVENTION

The invention is drawn to a game loader having a flat surface area, reinforced to enable use with heavy objects that is connected on one end to a stationary object, such as a tree or pole, and is connected on the other end to a vehicle or movable object, such that increased tension between these two points hoists the object loaded onto the game loader to a higher position, enabling the load to be rolled with little effort to the vehicles' loading platform. When not being used for this loading technique, the game loader can be extended over the vehicle to provide shelter and protection to the vehicle below.

### BRIEF DESCRIPTION OF THE DRAWINGS

The accompanying drawings illustrate an embodiment of this invention. However, it is to be understood that this embodiment is intended to be neither exhaustive, nor limiting of the invention. They are but examples of some of the forms in which the invention may be practiced.

FIG. 1 is a perspective view of the game loader.

FIG. 2 is a side view of the game loader in the loading position connected to a stationary object and to a vehicle.

FIG. 3 is a side view of the game loader in the lifted position.

FIG. 4 is a perspective view of the game loader used to cover and protect a vehicle.

FIG. 5 is a perspective view of the game loader used as a hammock or resting position for a user.

### DETAILED DESCRIPTION OF EXEMPLARY EMBODIMENTS

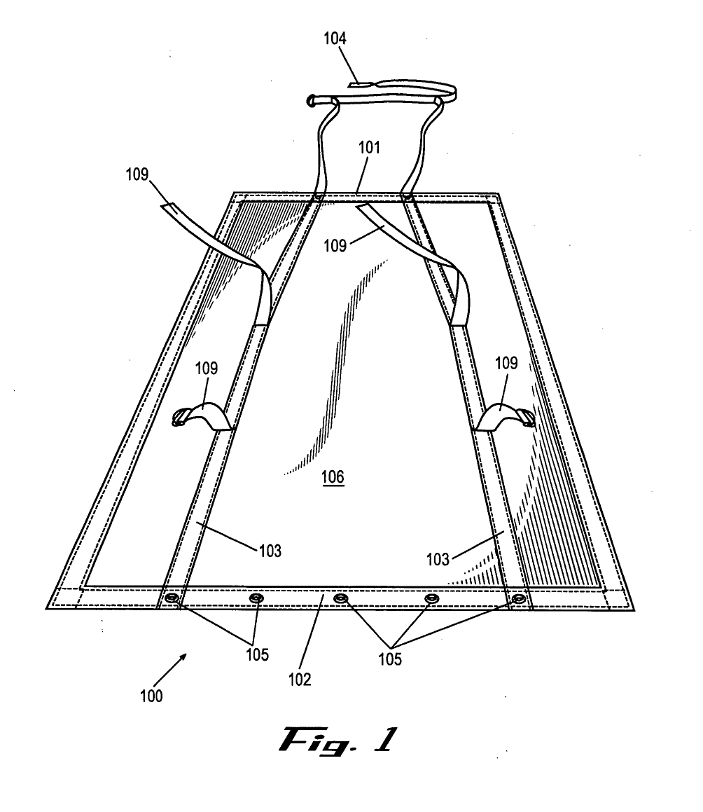

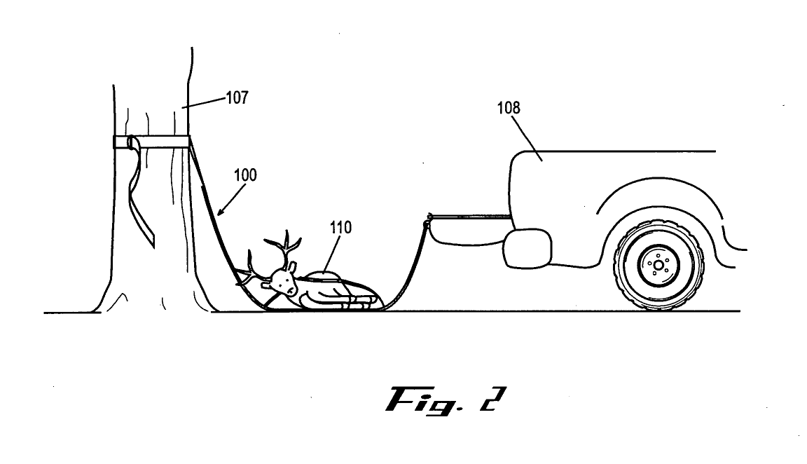

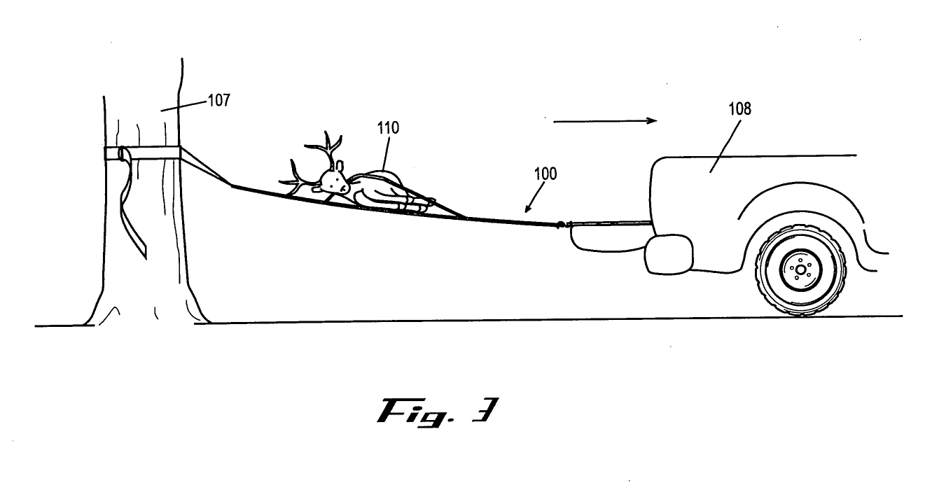

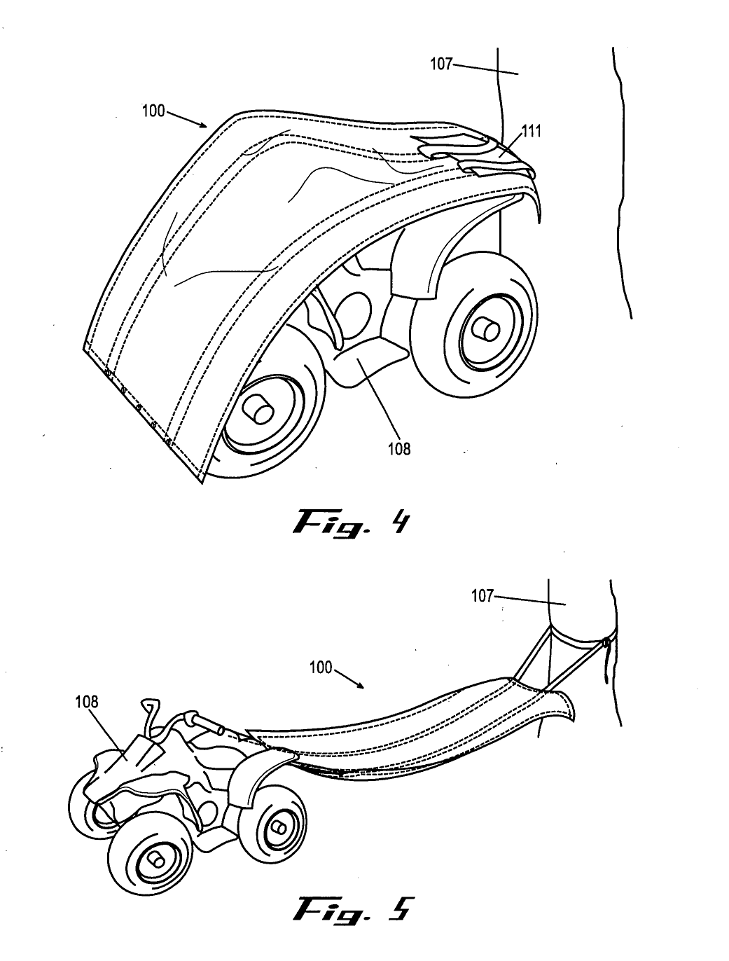

Without any intent to limit the scope of this invention, reference is made to the figures in describing the various embodiments of the invention. Referring to FIGS. 1 through 5, a game loader 100 is pictured.

The game loader 100 is constructed of a generally flat surface 106 such as a tarpaulin, constructed of a lightweight and durable material having a first end 101 and second end 102, and is generally longer than it is wide, though this is not necessary to effectuate the desired result. To reinforce the structural integrity of game loader 100, there will generally be at least one reinforcement strap 103 that runs parallel to the length of the game loader. These straps can also extend or even be part of the attachment section 104 and second attachment section 105 of game loader 100. Reinforcements strap 103 could also run perpendicular or even angularly, depending upon the application.

On first end 101, there is attachment section 104 used to connect to a stationary object 107 such as a tree or pole. On second end 102 is second attachment section 105 which is configured to be connected to movable object or vehicle 108. There will also generally be securing points 109 for use in securing the game 110 or load placed on game loader 100. First end 101 may also have a pocket 111 located on the flat surface 106 of game loader 100 so that attachment section 105 could be stored out of the way when not in use.

In operation, game loader 100 is opened up fully and attached on first end 101 to stationary object 107 such as a tree or a pole at approximately the same height as the loading area of vehicle 108, or slightly higher if possible. Game loader's 100 second end 102 is attached to vehicle 108 or other movable object. Stationary object 107 and vehicle 108 are spaced such that a portion of game loader's 100 surface is in contact with the ground below it. In this way, the game 110, or other load, can be drug or rolled onto this portion of the surface. Once properly positioned on game loader 100, securing points 109 are utilized to secure the game 110, or other load, on game loader 100.

Next, vehicle 108 is going to be slowly moved away from stationary object 107, such that tension is created across game loader 100 and thus, the portion of game loader 100 previously in contact with the ground will begin to rise upward until flat surface 106 is parallel, or nearly parallel with attachment point 104 and second attachment point 105. At this point, the movement of vehicle 108 should cease. Since second attachment point 105 is ideally somewhat lower than attachment point 104, a ramp of sorts with a slight incline is created. Securing points 109 can be released, and the game 110 slid or rolled onto the loading area of vehicle 108. Attachment point 104 can then be detached from stationary object 107 and game loader 100 positioned over game and secured for transport.

When not in use, game loader 100 can be used to cover vehicle 108 by using game loader 100 in a draped fashion over an all terrain vehicle or other desired object to be protected. Attachment point 104 can be used to secure game loader 100 in position over the object. This method has the effect of not only protecting, but, should game loader 100 be of a camouflage pattern, also concealing the valuable vehicle 108 beneath.

Also, while breaking or camping, game loader 100 can be attached to a stationary object 107 and to movable object 108 in order to created a flat surface on which to rest or lounge. The tension between stationary object 107 and movable object 108 can be adjusted to fit the preferences of the individual using game loader 100.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

1. A game loader comprising:
a. a tarpaulin having first and second ends and having a preconfigured length and width, wherein said length is generally greater than said width;
b. at least one reinforcement strap substantially parallel to said length of said tarpaulin configured to provide reinforcement of said tarpaulin;
c. said first end having an attachment section configured to be attached to a stationary object; and
d. said second end having a second attachment section configured to be attached to a vehicle.

2. A game loader according to claim 1 further comprising at least one securing point for retaining loaded objects.

3. A game loader according to claim 1 further comprising a pocket operatively attached on said game loader for holding objects.

4. A method for loading game utilizing the game loader of claim 1 comprising:
a. attaching said first end of said tarpaulin to a stationary object using said attachment section;
b. attaching said second end of said tarpaulin to a vehicle using said second attachment section;
c. placing game or other object on said tarpaulin;
d. moving said vehicle away from said stationary object such that tension is increased across the connection between the two formed by said tarpaulin;
e. manipulating said game onto the rear of said vehicle; and
f. detaching said tarpaulin from said stationary object.

5. A method for covering and protecting a vehicle utilizing the game loader of claim 1 comprising substantially covering said vehicle with said tarpaulin.

6. A method for covering and protecting a vehicle according to claim 5 further comprising the step of attaching said second end of said tarpaulin to said vehicle using said second attachment section to keep said tarpaulin in place.

7. A method for constructing a sleeping device utilizing the game loader of claim 1 comprising:
a. attaching said first end of said tarpaulin to said stationary object using said attachment section;
b. attaching said second end of said tarpaulin to said vehicle using said second attachment section; and
c. moving said vehicle such that the desired tautness of said tarpaulin is achieved.

8. A method for loading game utilizing the game loader of claim 2 comprising:
a. attaching said first end of said tarpaulin to a stationary object using said attachment section;
b. attaching said second end of said tarpaulin to a vehicle using said second attachment section;
c. placing game or other object on said tarpaulin;
d. moving said vehicle away from said stationary object such that tension is increased across the connection between the two formed by said tarpaulin;
e. manipulating said game onto the rear of said vehicle; and
f. detaching said tarpaulin from said stationary object.

9. A method for covering and protecting a vehicle utilizing the game loader of claim 1 comprising substantially covering said vehicle with said tarpaulin.

10. A method for covering and protecting a vehicle according to claim 9 further comprising the step of attaching said second end of said tarpaulin to said vehicle using said second attachment section to keep said tarpaulin in place.

11. A method for constructing a sleeping device utilizing the game loader of claim 2 comprising:
a. attaching said first end of said tarpaulin to said stationary object using said attachment section;
b. attaching said second end of said tarpaulin to said vehicle using said second attachment section; and
c. moving said vehicle such that the desired tautness of said tarpaulin is achieved.
